(19) United States
(12) Patent Application Publication
(10) Pub. No.: US 2010/0067609 A1
(43) Pub. Date: Mar. 18, 2010

(54) System, transmitting apparatus and receiving apparatus for cancelling co-channel interferences and method thereof

(76) Inventor: Zhi WANG, Beijing (CN)

Correspondence Address: DOWELL & DOWELL P.C., 103 Oronoco St., Suite 220, Alexandria, VA, 22314, US

(21) Appl. No.: 12/453,939

(22) Filed: May 27, 2009

(30) Foreign Application Priority Data
Sep. 18, 2008 (CN) 200810222605.X

(51) Int. Cl. H04B 15/00; H04L 25/49; H04L 1/00

(52) U.S. Cl. 375/285; 375/296; 375/348

(57) ABSTRACT

The present invention discloses a system and method for cancelling co-channel interferences, including: grouping, interleaving and repeating initial data blocks to generate logical data blocks, permutating the logical data blocks to generate physical data blocks, and transmitting the physical data blocks; receiving, de-permutating and de-interleaving the physical data blocks to generate interleaved logical data blocks, separating and estimating physical channels of an objective base station and neighboring base stations according to preamble symbols or pilot symbols, de-permutating and de-interleaving estimated physical channels to generate estimated logical channels, constructing estimated logical channel matrixes by using the estimated logical channels, computing weighted coefficients according to the estimated logical channel matrixes, equalizing the interleaved logical data blocks by using the weighted coefficients to generate equalized logical data blocks, recovering the equalized logical data blocks to generate the initial data blocks. The co-channel interferences are eliminated and the reliability of the communication system is improved according to the present invention.

### BACKGROUND OF THE INVENTION

1. Field of the Invention

The present invention generally relates to wireless communication field and especially to a system, a transmitting apparatus, and a receiving apparatus for cancelling co-channel interferences and a method thereof.

2. Brief Description of the Related Arts

Co-channel interference from neighboring cells is an important issue in high speed wireless communication system. Generally, in WiMAX (Worldwide Interoperability for Microwave Access) and 3GPP LTE standards, code repetition technology is adopted to enhance Signal-to-noise Ratio characteristics, and Maximum Ratio Combining (MRC) technology is used at receiver for combining repeated codes to reduce the Packet Error Rate (PER) and Bit Error Rate (BER). As well known, MRC technology is an optimal combining technology for cancelling Additive White Gaussian Noises (AWGN). However, at cell edge, the Co-Channel Interference (CCI) is very strong and belongs to Narrowband Interference which is different from AWGN. In this case, the satisfied PER and BER would be hardly achieved based on the MRC technology.

FIG. 1 is a schematic diagram showing an example of a cell being subjected to co-channel interferences according to the prior art. In FIG. 1, each hexagon indicates a cell covered by a base station and the base station is located at the center of each cell. A triangle area belongs to an overlapping area of three cells. For example, a mobile terminal of cell 1 in the overlapping area is subjected to strong interference signals from base stations 2 and 3. A rectangular area belongs to an overlapping area of two cells. For example, a mobile terminal of cell 1 in the overlapping area is subjected to strong interference signals from base station 2.

FIG. 2 is a diagram showing a distribution of sectors of cell 1 according to the prior art. In FIG. 2, cell 1 consists of a first sector 101, a second sector 102 and a third sector 103.

FIG. 3 is a schematic diagram showing a cell when a SIR (signal to Interference ratio) is the worst with frequency reuse 1/3/1. According to the MRC technology, frequency reuse 1/3/1 refers to that a cell includes three sectors and the three sectors share one frequency band. In FIG. 3, there are cells r₀, r₁, r₂, r₃, r₄, and r₅, wherein r₀ is covered by a base station located at the center of the cell. At a position o of cell r₀, there are interferences from cells r₁, r₂, r₃, r₄, and r₅, and an overall strength of these interference signals is −8.9807 dB.

FIG. 4 is a schematic diagram showing a simulation result of using the MRC with the frequency reuse 1/3/1, wherein the ordinate axes indicates PER and the abscissa axes indicates SNR (signal to noise ratio) and the simulation environment is set as follows:

downlink: PUSC (Partial Usage Of Subchannels);

modulation mode: QPSK (Quadrature Phase Shift Keying);

code rate: ½;

data block size: 100 bytes;

co-channel interferences: a first co-channel interference with a SIR of 0 dB, a second co-channel interference with a SIR of 10 dB;

communication channel: ITU Ped-B (3 km/h);

combining technology adopted by a receiver: MRC; and

channel estimation method: ideal channel estimation.

Three simulation curves A, B and C in FIG. 4 show simulation results under different simulation conditions.

The simulation condition of curve A is:

code repetition rate: 4; and

antenna structure: SISO (Single Input Single Output), i.e. one transmitting antenna and one receiving antenna.

The simulation condition of curve B is:

code repetition rate: 6; and

antenna structure: SISO (Single Input Single Output), i.e. one transmitting antenna and one receiving antenna.

The simulation condition of curve C is:

code repetition rate: 4; and

antenna structure: SIMO (Single Input Multi Output) 1×2, i.e. one transmitting antenna and two receiving antennas.

In MRC technology, frequency reuse 1/3/1 refers to that one base station includes three sectors and the three sectors share one frequency band. In this case, since three sectors share one frequency band, a comparatively high frequency resource utilization ratio would be obtained. However, a problem of severe interferences (especially co-channel interferences) still exists. Since the co-channel interference is the narrow band interference, the code repetition technology, MRC technology and HARQ (Hybrid Automatic Repeat Request) technology according to the prior art cannot resolve the problem of the co-channel interference appropriately.

### SUMMARY OF THE INVENTION

An objective of the present invention is to provide a system, a transmitting apparatus and a receiving apparatus for cancelling co-channel interferences and a method thereof, which can improve a reliability of a communication system and at the same time improve resource utilization ratio most effectively and reduce PER and BER.

According to one aspect of an embodiment of the present invention, there is provided a system for cancelling co-channel interferences, the system comprising:

a transmitting apparatus and a receiving apparatus, wherein,

the transmitting apparatus comprises:

a grouping module that groups the initial data blocks to generate grouped logical data blocks;

an interleaving module that interleaves the grouped logical data blocks to generate interleaved logical data blocks;

a repetition module that repeats the interleaved logical data blocks to generate repeated logical data blocks;

a permutation module that permutates the repeated logical data blocks to generate permutated physical data blocks; and

a transmitting module that transmits the permutated physical data blocks in a predefined manner;

the receiving apparatus comprises:

a receiving module that receives the physical data blocks in the predefined manner;

a data de-permutation module that de-permutates the received physical data blocks to generates de-permutated logical data blocks;

a data de-interleaving module that de-interleaves the de-permutated logical data blocks to generate de-interleaved logical data blocks;

a channel estimation module that separates and estimates physical channels of an objective base station and neighboring base stations according to preamble symbols or pilot symbols, de-permutates the estimated physical channels to generate the de-permutated estimated logical channels, de-interleaves the de-permutated estimated logical channels to generate the interleaved estimated logical channels, constructs the estimated logical channel matrixes by using the de-interleaved estimated logical channels, and computes weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;

an equalizing module that equalizes the interleaved logical data blocks by using the weighted coefficients to generate the equalized logical data blocks; and

a recovering module that recovers the equalized logical data blocks to generate the initial data blocks.

According to another aspect of the embodiment of the present invention, there is provided a transmitting apparatus for cancelling co-channel interferences, the transmitting apparatus comprising:

a grouping module that groups the initial data blocks to generate grouped logical data blocks;

an interleaving module that interleaves the grouped logical data blocks to generate interleaved logical data blocks;

a repetition module that repeats the interleaved logical data blocks to generate repeated logical data blocks;

a permutation module that permutates the repeated logical data blocks to generate permutated physical data blocks; and

a transmitting module that transmits the permutated physical data blocks in a predefined manner.

According to another aspect of the embodiment of the present invention, there is provided a transmitting apparatus for cancelling co-channel interferences, the transmitting apparatus comprising:

a grouping module that groups the initial data blocks to generate grouped logical data blocks;

a repetition module that repeats the grouped logical data blocks to generate repeated logical data blocks;

an interleaving module that interleaves the repeated logical data blocks to generate interleaved logical data blocks;

a permutation module that permutates the repeated logical data blocks to generate permutated physical data blocks; and

a transmitting module that transmits the permutated physical data blocks in a predefined manner.

According to another aspect of the embodiment of the present invention, there is provided a receiving apparatus for cancelling co-channel interferences, the receiving apparatus comprising:

a receiving module that receives the physical data blocks in a predefined manner;

a data de-permutation module that de-permutates the received physical data blocks to generates de-permutated logical data blocks;

a data de-interleaving module that de-interleaves the de-permutated logical data blocks to generate de-interleaved logical data blocks;

a channel estimation module that separates and estimates physical channels of an objective base station and neighboring base stations according to preamble symbols or pilot symbols, de-permutates the estimated physical channels to generate the de-permutated estimated logical channels, de-interleaves the de-permutated estimated logical channels to generate the interleaved estimated logical channels, constructs the estimated logical channel matrixes by using the de-interleaved estimated logical channels, and computes weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;

an equalizing module that equalizes the interleaved logical data blocks by using the weighted coefficients to generate the equalized logical data blocks; and

a recovering module that recovers the equalized logical data blocks to generate the initial data blocks.

According to another aspect of the embodiment of the present invention, there is provided a method for cancelling co-channel interferences, the method comprising:

grouping the initial data blocks to generate grouped logical data blocks;

interleaving the grouped logical data blocks to generate interleaved logical data blocks;

repeating the interleaved logical data blocks to generate repeated logical data blocks;

permutating the repeated logical data blocks to generate permutated physical data blocks; and

transmitting the permutated physical data blocks in a predefined manner. receiving the physical data blocks in the predefined manner;

de-permutating the received physical data blocks to generate de-permutated logical data blocks;

de-interleaving the de-permutated logical data blocks to generate de-interleaved logical data blocks;

separating and estimating physical channels of an objective base station and neighboring base stations according to the preamble symbols or the pilot symbols, de-permutating the estimated physical channels to generate the de-permutated estimated logical channels, de-interleaving the de-permutated estimated logical channels to generate the interleaved estimated logical channels; constructing the estimated logical channel matrixes by using the de-interleaved estimated logical channels, computing weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;

equalizing the interleaved logical data blocks by using the weighted coefficients to generate the equalized logical data blocks; and

recovering the equalized logical data blocks to generate the initial data blocks.

According to another aspect of the embodiment of the present invention, there is provided a method for cancelling co-channel interferences, the method comprising:

grouping the initial data blocks to generate grouped logical data blocks;

repeating the grouped logical data blocks to generate repeated logical data blocks;

interleaving the repeated logical data blocks to generate interleaved logical data blocks;

permutating the repeated logical data blocks to generate permutated physical data blocks; and

transmitting the permutated physical data blocks in a predefined manner.

receiving the physical data blocks in the predefined manner;

de-permutating the received physical data blocks to generate de-permutated logical data blocks;

de-interleaving the de-permutated logical data blocks to generate de-interleaved logical data blocks;

separating and estimating physical channels of an objective base station and neighboring base stations according to the preamble symbols or the pilot symbols, de-permutating the estimated physical channels to generate the de-permutated estimated logical channels, de-interleaving the de-permutated estimated logical channels to generate the interleaved estimated logical channels; constructing the estimated logical channel matrixes by using the de-interleaved estimated logical channels, computing weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;

equalizing the interleaved logical data blocks by using the weighted coefficients to generate the equalized logical data blocks; and

recovering the equalized logical data blocks to generate the initial data blocks.

According to the system, the transmitting apparatus and the receiving apparatus for cancelling the co-channel interferences and the method thereof, the initial data blocks are grouped, interleaved, repeated and permutated at the transmitting side, physical channels of the objective base station and the neighboring base stations are separated and estimated according to the preamble symbols or the pilot symbols, and the received data blocks are de-permutated, de-interleaved, equalized and recovered at the receiving part, so that the PER and BER at cell edge are greatly reduced and the reliability of the communication system is enhanced and at the same time the resource utilization ratio is improved most efficiently.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a schematic diagram showing an example of a cell being subjected to co-channel interferences according to the prior art;

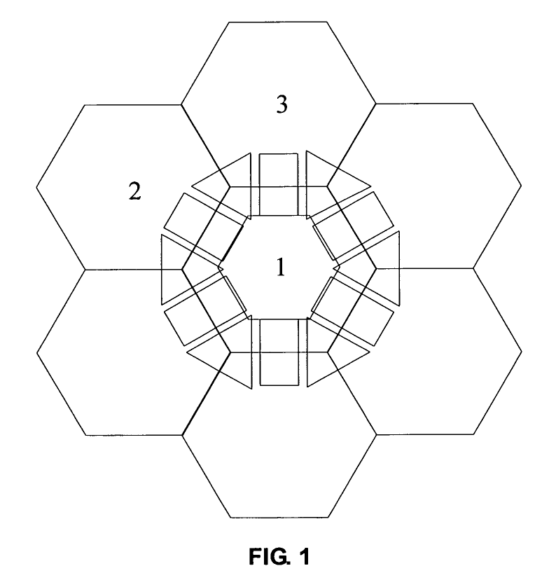

FIG. 2 is a diagram showing a distribution of sectors of cell 1 according to the prior art;

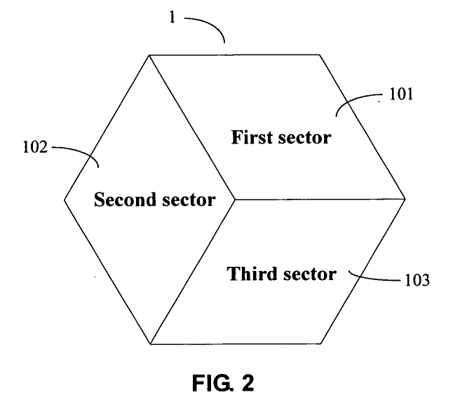

FIG. 3 is a schematic diagram showing a cell when a SIR (signal to Interference ratio) is the worst with frequency reuse 1/3/1;

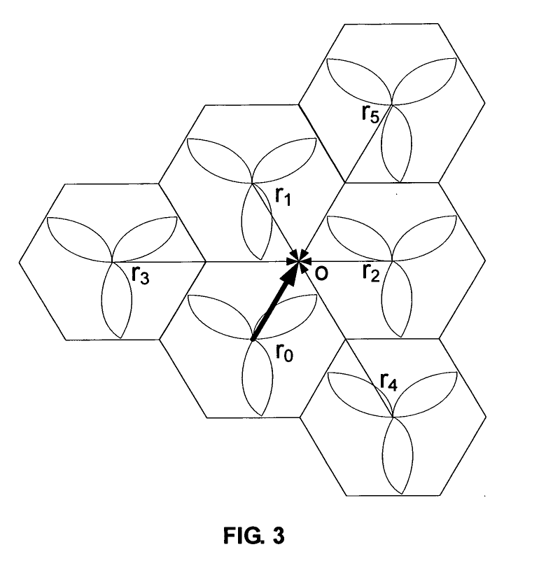

FIG. 4 is a schematic diagram showing a simulation result of using the MRC with the frequency reuse 1/3/1;

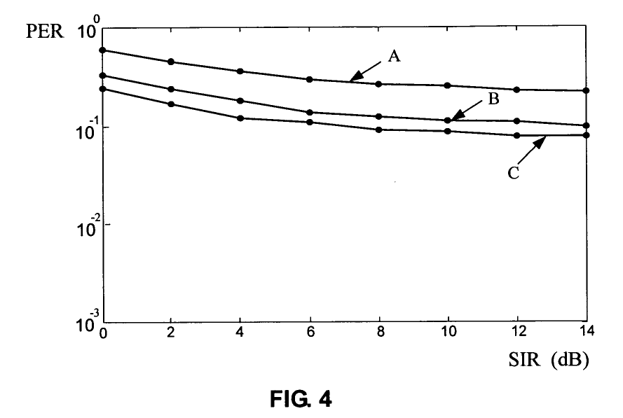

FIG. 5 is a block diagram of a system for cancelling co-channel interferences according to embodiments of the present invention;

FIG. 6 is a flow chart showing a method for cancelling co-channel interferences according to embodiments of the present invention; and

FIG. 7 is a schematic diagram showing a comparison of simulation results of the present invention and the prior art under the condition of 0 dB and 10 dB co-channel interferences respectively.

### DETAILED DESCRIPTION OF THE INVENTION

Exemplary embodiments of the present invention are described in detail below with reference to the accompanying drawings.

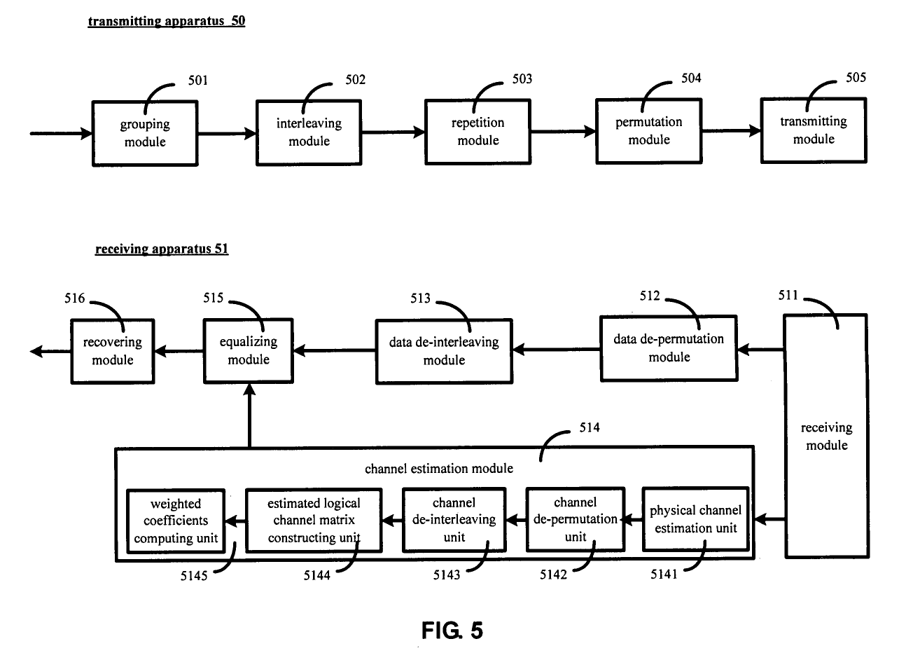

FIG. 5 is a block diagram of a system for cancelling co-channel interferences according to embodiments of the present invention, the block diagram comprises a transmitting apparatus 50 and a receiving apparatus 51, wherein,

The transmitting apparatus 50 comprises a grouping module 501, an interleaving module 502, a repetition module 503, a permutation module 504 and a transmitting module 505, wherein,

The grouping module 501 groups initial data blocks S_{Org}^{k} to generate grouped logical data blocks S_{Org}_{_{—}}ⱼ^{k}. The initial data blocks S_{Org}^{k} may be coded and modulated data blocks or un-coded and un-modulated data blocks. The k in S_{Org}^{k} and S_{Org}_{_{—}}ⱼ^{k} indicates an identification of a base station. For example, when k=1, S_{Org}¹ indicates the initial data blocks of the first base station. The j in S_{Org}_{_{—}}ⱼ^{k} indicates an identification of a logical subcarrier. For example, when j=1, S_{Org}_{_{—}}ⱼ^{k}indicates logical data among the logical data blocks and carried by the first logical subcarrier.

The logical data block is for recombining information bits at an appropriate place of the physical layer, wherein the information bits are transmitted from the MAC (media access control) layer to the physical layer. The information bits are the initial data blocks. The size of the logical data block is usually determined by the number of subcarriers and their repetition times in each data symbol. If there is no specific illustration, here and hereinafter, the data symbol refers to OFDM (Orthogonal Frequency Division Multiplexing) data symbol. For example, in 1024 FFT OFDM data symbol, if the number of the subcarriers is 840 and the repetition rate is 3, the size of the logical data block is 280 subcarriers; if the number of the subcarriers is 720 and the repetition rate is 3, the size of the logical data block is 240 subcarriers. Different coding methods and different modulation modes may be utilized for the data in the logical data block.

The grouped logical data blocks may include a plurality of data packets and each data packet may be divided into multiple data blocks. The data packet is a data block transmitted from the MAC layer to the physical layer in the wireless communication system, for example, the data packet may include voice, image data information and related control information. The definition of the data packet is determined by the MAC layer.

The interleaving module 502 interleaves the grouped logical data blocks S_{Org}_{_{—}}ⱼ^{k} to generate interleaved logical data blocks Sᵢ^{k} as shown in equation (1).

Sᵢ^{k}=fᵢₙₜₑᵣ(S_{Org}_{_{—}}ⱼ^{k}) (1)

In equation (1), fᵢₙₜₑᵣ( ) is an interleaving function.

The repetition module 503 repeats the interleaved logical data blocks Sᵢ^{k} to generate repeated logical data blocks Xᵢ^{k} as shown in equation (2).

Xᵢ^{k}=[Sᵢ^{k} S_{i+M}^{k}S_{i+2M}^{k} . . . S_{i+(N-1)M}^{k}]^{T} (2)

S_{i+M}^{k}, S_{i+2M}^{k}, . . . , S_{i+(N-1)M}^{k} at the right side of equation (2) indicate logical data blocks which are the same as the logical data blocks Sᵢ^{k}.

The repetition module 503 repeats the logical data blocks in a predefined manner. The size and repetition times of logical data blocks of different base stations may be in consistent with each other. Generally, the size of the FFT and the repetition times determine the size of the logical data blocks. For example, for a cellular network wherein each cell has three sectors, the logical data blocks are normally repeated two times in the OFDM symbols, i.e. the size of the logical data block is ⅓ of the number of the data subcarriers, but of course different repetition times may be selected according to different network distribution and different number of base station sectors.

The interleaving of the grouped logical data blocks performed by the interleaving module 502 is actually the re-sequencing of the logical subcarriers in the grouped logical data blocks. The interleaving process of the logical data blocks may be performed after the grouping process or after the repetition process. If the logical data blocks are interleaved after the repetition process, each repeated logical data block may be interleaved and different interleaving method may be utilized to interleave each different repeated logical data block.

The sequence of the interleaving module 502 and the repetition module 503 may be changed each other, i.e. the repetition module 503 repeats the grouped logical data blocks S_{Org}_{_{—}}ⱼ^{k} to generate the repeated data blocks Xᵢ′^{k} as shown in equation (3) firstly.

Xᵢ′^{k}=[S_{Org}_{_{—}}ⱼ^{k}S_{Org}_{_{—}}_{j+M}^{k}S_{Org}_{_{—}}_{j+2M}^{k} . . . S_{Org}_{_{—}}_{j+(N-1)M}^{k}]^{T} (3)

S_{Org}_{_{—}}_{j+M}^{k}, S_{Org}_{_{—}}^{j+2M}^{k}, . . . , S_{Org}_{_{—}}_{j+(N-1)M}^{k} at the right side of equation (3) indicate logical data blocks which are the same as the logical data blocks S_{Org}_{_{—}}ⱼ^{k}.

Then the interleaving module 502 interleaves the repeated logical data blocks to generate the interleaved logical data blocks Sᵢ′^{k} as shown in equation (4).

Sᵢ′^{k}=[fᵢₙₜₑᵣ_{_{—}}₁(S_{Org}_{_{—}}ⱼ^{k})fᵢₙₜₑᵣ_{_{—}}₂(S_{Org}_{_{—}}_{j+M}^{k})fᵢₙₜₑᵣ_{_{—}}₃(S_{Org}_{_{—}}_{j+2M}^{k}) . . . fᵢₙₜₑᵣ_{_{—}}_{N}(S_{Org}_{_{—}}_{j+(N-1)M})]^{T} (4)

In equation (4), Fᵢₙₜₑᵣ_{_{—}}ᵢ( ), (i=1,2, . . . N) shows different interleavers are used for repeated logical data blocks Xᵢ′^{k}, such as interleavers fᵢₙₜₑᵣ_{_{—}}₁( ), fᵢₙₜₑᵣ_{_{—}}₂( ), . . . , fᵢₙₜₑᵣ_{_{—}}ᵢ( ). M indicates the size of the data blocks, and also indicates the number of the logical subcarriers carrying the data blocks.

The interleaving method adopted by the interleaving module 502 is a permutation of row and column elements, as shown in equation (5):

$${Input sequence \text{:}}_{{s}_{11} {s}_{12} … {s}_{1 N} {s}_{21} {s}_{22} … {s}_{2 N} … {s}_{PN}} [ \begin{matrix}{s}_{11} {s}_{12} {s}_{13} … {s}_{1 N} \\ {s}_{21} {s}_{22} {s}_{23} … {s}_{2 N} \\ ⋮ … \\ {s}_{P 1} {s}_{P 2} {s}_{P 3} … {s}_{PN}\end{matrix} ] {↓ Output sequence \text{:} }_{{s}_{11} {s}_{21} … {s}_{P 1} {s}_{12} {s}_{22} … {s}_{P 2} … {s}_{PN}} \qquad ( 5 )$$

In equation (5), the size of the logical data blocks equals to the product of the N and P in the input or output sequences.

If the repeated logical data blocks are to be interleaved, the column and the row of the interleaving matrixes may be different.

The permutation module 504 permutates the repeated logical data blocks Xᵢ^{k} to generate permutated physical data blocks Xᵢ_{_{PHY}}^{k}. The permutation module 504 transforms the logical sequence of repeated data blocks Xᵢ^{k} to the physical sequence, i.e. the permutation module 504 transforms the repeated logical data blocks Xᵢ^{k} to permutated physical data blocks Xᵢ_{_{PHY}}^{k} as shown in equation (6).

Xᵢ_{_{PHY}}^{k}=f_{Permut}(Xᵢ^{k}) (6)

In equation (6), f_{Permut}( ) is a permutation function.

In order to guarantee that the logical channels corresponding to the repeated logical data blocks maintain relative independency, the permutation may be a random interleaving covering all the data subcarriers and may be the permutation methods of the prior art such as the permutation methods of PUSC and AMC (Advanced Modulation Coding) adopted in WiMAX. Generally, different permutation methods may be utilized for data blocks of different base stations.

The transmitting module 505 transmits the permutated physical data blocks Xᵢ_{_{PHY}}^{k} in a predefined manner.

The receiving apparatus 51 is described in detail as follows. The receiving apparatus 51 comprises a receiving module 511, a data de-permutation module 512, a data de-interleaving module 513, a channel estimation module 514, an equalizing module 515 and a recovering module 516.

The receiving module 511 receives the physical data blocks Zᵢ_{_{PHY}}^{l} transmitted from the transmitting module 505 in a predefined manner, wherein the physical data blocks Zᵢ_{_{PHY}}^{l} are shown as equation (7):

$${Z}_{{i}_{PHY}}^{l} = {\sum }_{k = 1}^{K} {Ψ}_{{i}_{PHY}}^{lk} {X}_{{i}_{PHY}}^{k} + {N}_{{i}_{PHY}}^{l} \qquad ( 7 )$$

In equation (7), l indicates a name of a receiving antenna; Ψᵢ_{_{PHY}}^{lk} indicates a physical channel from the k_th base station to the l_th receiving antenna; Xᵢ_{_{PHY}}^{k} indicates permutated physical data blocks; and Nᵢ_{_{PHY}}^{l} indicates AWGN.

The data de-permutation module 512 de-permutates the received physical data blocks Zᵢ_{_{PHY}}^{l} to generate the logical data blocks Z_{DP}_{_{—}}ᵢ^{l} as shown in equation (8):

Z_{DP}_{_{—}}ᵢ^{l}=f_{DE-Permut}(Zᵢ_{_{PHY}}^{l}) (8)

In equation (8), f_{DE-Permut}( ) is a de-permutation function.

The data de-interleaving module 513 de-interleaves the logical data blocks Z_{DP}_{_{—}}ᵢ^{l} to generate the de-interleaved logical data blocks Zᵢ^{l} as shown in equations (9) and (10):

Zᵢ^{l}=f_{DE}_{_{—}}_{Inter}(Z_{DP}_{_{—}}ₙ^{l}) (9)

In equation (9), f_{DE}_{_{—}}_{Inter}( ) is a de-interleaving function.

Zᵢ^{l}=[Yᵢ^{l} Y_{i+M}^{l} . . . Y_{i+(N-1)M}^{l}]^{T} (10)

The right side of equation (10) indicates interleaved logical data block vectors.

The channel estimation module 514 estimates the physical channels then performs a matching process for the estimated physical channels. The channel estimation may be the time domain estimation or the frequency domain estimation of the physical channels. The matching process is for transforming the estimated physical channels according to the received physical data symbols and making the transformed estimated physical channels to correspond to the physical data symbols. For example, the physical data symbols includes 1024 subcarriers and if the estimated physical channels in the time domain are obtained by using the method of the time domain estimation, FFT transformation may be performed for the estimated physical channels in the time domain and the estimated physical channels in the frequency domain are obtained. If FFT points of the estimated physical channels do not correspond to FFT points of the logical data blocks, an interpolation and smoothing process or a decimation process or other corresponding processes may be performed for the estimated physical channels.

The channel estimation module 514 comprises: a physical channel estimation unit 5141, a channel de-permutation unit 5142, a channel de-interleaving unit 5143, an estimated logical channel matrix constructing unit 5144 and a weighted coefficient computing unit 5145.

The physical channel estimation unit 5141 separates and estimates the estimated physical channels \hat{Ψ}ᵢ_{_{PHY}}^{lk} according to received preamble symbols or pilot symbols.

The preamble symbols or the pilot symbols are capable of separating and estimating physical channels from different base stations. Therefore, channels leading to the objective base station and neighboring base stations can be separated according to the preamble symbols or the pilot symbols, wherein the physical channels leading to the objective base station are channels from the objective base station to the mobile communication terminals and the physical channels leading to the neighboring base stations are channels from the neighboring base stations to the mobile communication terminals. Moreover, the preamble symbols or the pilot symbols may be symbols of the OFDM data type or of other data types. The preamble symbols or the pilot symbols are utilized to separate and estimate the physical channels from different base stations.

The channel de-permutation unit 5142 de-permutates the estimated physical channels to generate the de-permutated estimated logical channels \hat{Ψ}_{DP}_{_{—}}ᵢ^{lk} as shown in equation (11):

\hat{Ψ}_{DP}_{_{—}}ᵢ^{lk}=f_{DE-Permut}(\hat{Ψ}ᵢ_{_{—}}^{lk}) (11)

In equation (11), f_{DE-Permut}( ) is a de-permutation function.

The channel de-interleave unit 5143 de-interleaves the estimated physical channels \hat{Ψ}_{DP}_{_{—}}ᵢ^{lk} to generate the de-interleaved estimated logical channels \hat{Ψ}ᵢ^{lk} as shown in equation (12) and (13):

\hat{Ψ}ᵢ^{lk}=f_{DE}_{_{—}}_{Inter}(\hat{Ψ}_{DP}_{_{—}}ₙ^{lk}) (12)

\hat{Ψ}ᵢ^{lk}=[Ĥᵢ^{lk} Ĥ_{i+M}^{lk} . . . Ĥ_{i+(N-1)M}^{lk}]^{T} (13)

In equation (12), f_{DE}_{_{—}}_{Inter} is a de-interleaving function. The channel de-interleaving unit 5143 corresponds to the interleaving module 502 in the transmitting apparatus 50, i.e. the interleaver used by the channel de-interleaving unit 5143 corresponds to the interleaver used by the interleaving module 502. When the repeated logical data blocks are interleaved and the interleavers in the transmitting apparatus 50 for different repeated data blocks are different, the de-interleavers in the receiving apparatus 51 are different and the de-interleavers in the receiving apparatus 51 correspond to the interleavers in the transmitting apparatus 50 one to one.

In equation (13), \hat{Ψ}ᵢ^{lk} are the estimated logical channels after de-permutation process and de-interleaving process.

The estimated logical channel matrix constructing unit 5144 constructs the estimated logical channel matrix Ĥᵢ^{l} according to the de-interleaved estimated logical channels \hat{Ψ}ᵢ^{lk} and Ĥᵢ^{l} is shown in equation (14):

$${\hat{H}}_{i}^{l} = [ \begin{matrix}{\hat{H}}_{i}^{l 1} & {\hat{H}}_{i}^{l 2} & … & {\hat{H}}_{i}^{lK} \\ {\hat{H}}_{i + M}^{l 1} & {\hat{H}}_{i + M}^{l 2} & … & {\hat{H}}_{i + M}^{lK} \\ ⋮ & … & … & \\ {\hat{H}}_{i + ( N - 1 ) M}^{l 1} & {\hat{H}}_{i + ( N - 1 ) M}^{l 2} & … & {\hat{H}}_{i + ( N - 1 ) M}^{lK}\end{matrix} ] \qquad ( 14 )$$

Equation (15) is obtained according to equations (7), (13) and (14):

$$[ \begin{matrix}{Y}_{i}^{l} \\ {Y}_{i + M}^{l} \\ ⋮ \\ {Y}_{i + ( N - 1 ) M}^{l}\end{matrix} ] = [ \begin{matrix}{\hat{H}}_{i}^{l 1} & {\hat{H}}_{i}^{l 2} & … & {\hat{H}}_{i}^{lK} \\ {\hat{H}}_{i + M}^{l 1} & {\hat{H}}_{i + M}^{l 2} & … & {\hat{H}}_{i + M}^{lK} \\ ⋮ & … & … & \\ {\hat{H}}_{i + ( N - 1 ) M}^{l 1} & {\hat{H}}_{i + ( N - 1 ) M}^{l 2} & … & {\hat{H}}_{i + ( N - 1 ) M}^{lK}\end{matrix} ] [ \begin{matrix}{S}_{i}^{1} \\ {S}_{i}^{2} \\ ⋮ \\ {S}_{i}^{K}\end{matrix} ] + {N}_{i}^{l} \qquad ( 15 )$$

The weighted coefficient computing unit 5145 computes the weighted coefficients W_{Ki} according to the estimated logical channel matrixes Ĥᵢ^{l} and W_{Ki} is shown in equation (16):

W_{Ki}= [symbol] (Ĥᵢ^{l}) (16)

[symbol] ( ) in equation (16) is a function under different estimation principles. For example, if the MMSE (Minimum Mean Square Error) estimation principle is used, the weighted coefficient W_{Ki} is shown as equation (17):

W_{Ki}=(R_{N}_{ᵢ}^{l}+Ĥᵢ^{lT}Hᵢ^{l})⁻¹Hᵢ^{lT} (17)

In equation (17), R_{N}_{ᵢ}^{l} is the variance matrix of the AWGN.

The equalizing module 515 equalizes the interleaved logical data blocks Zᵢ^{l} by using the weighted coefficients W_{Ki} to generate the equalized logical data blocks Ŝᵢ^{k} as shown in equation (18):

Ŝᵢ^{k}=W_{Ki}Zᵢ^{l} (18)

The recovering module 516 recovers the equalized logical data blocks Ŝᵢ^{k} to generate the initial data blocks S_{Org}^{k}.

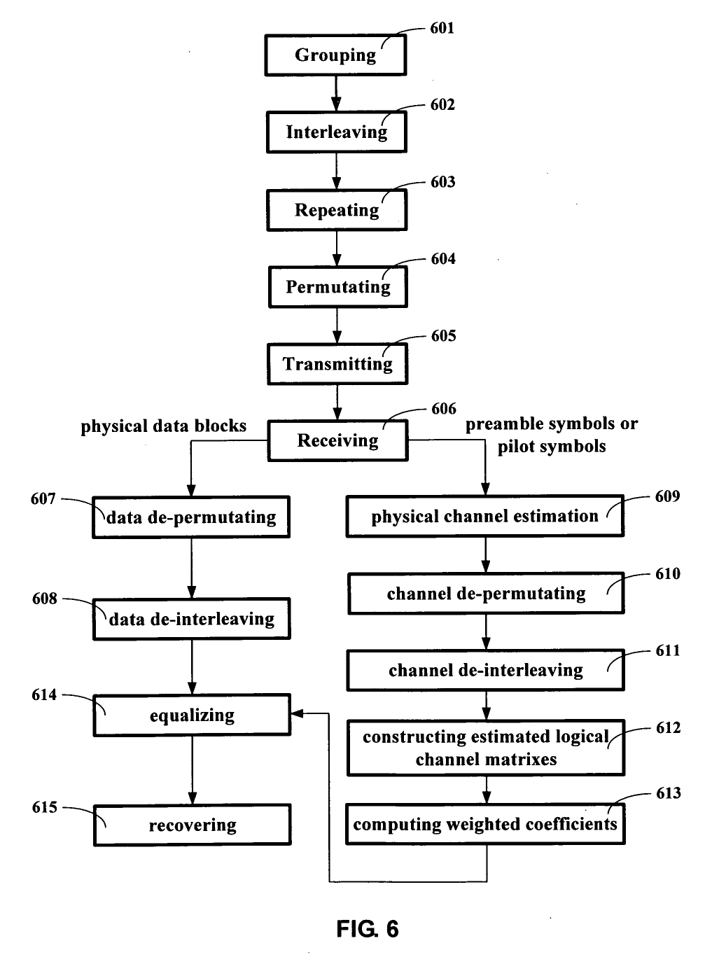

FIG. 6 is a flow chart showing a method for cancelling co-channel interferences according to embodiments of the present invention and the specific steps are as following.

Step 601, the initial data blocks S_{Org}^{k} are grouped to generate the grouped logical data blocks S_{Org}_{_{—}}ⱼ^{k}.

Step 602, the grouped logical data blocks S_{Org}_{_{—}}ⱼ^{k} are interleaved to generate the interleaved logical data blocks Sᵢ^{k}.

Step 603, the interleaved logical data blocks Sᵢ^{k} are repeated to generate the repeated logical data blocks Xᵢ^{k}.

In steps 602 and 603, the interleaving for the grouped logical data blocks are actually the re-sequencing of the logical subcarriers in the grouped logical data blocks. The order of step 602 and step 603 may be changed, i.e. the interleaving process may be performed after the grouping process or after the repetition process. If the logical data block is interleaved after the repetition process, each repeated logical data block may be interleaved and different interleaving method may be used to interleave each different repeated logical data block.

Step 604, the repeated data blocks Xᵢ^{k} are permutated to generate the physical data blocks Xᵢ_{_{PHY}}^{k}.

Step 605, the permutated physical data blocks Xᵢ_{_{PHY}}^{k} are transmitted in a predefined manner.

Step 606, the physical data blocks Zᵢ_{_{PHY}}^{l} are received in the predefined manner.

Step 607, the received physical data blocks Zᵢ_{_{PHY}}^{l} are de-permutated to generate the logical data blocks Z_{DP}_{_{—}}ᵢ^{l}.

Step 608, the logical data blocks Z_{DP}_{_{—}}ᵢ^{l} are de-interleaved to generate the de-interleaved logical data blocks Zᵢ^{l}.

Step 609, the physical channels \hat{Ψ}ᵢ_{_{PHY}}^{lk} are separated and estimated according to the received preamble symbols or pilot symbols.

Step 610, the estimated physical channels \hat{Ψ}ᵢ_{_{PHY}}^{lk} are de-permutated to generate the estimated logical channels \hat{Ψ}_{D}_{_{—}}ᵢ^{lk}.

Step 611, the estimated logical channels \hat{Ψ}_{DP}_{_{—}}ᵢ^{lk} are de-interleaved to generate the de-interleaved estimated logical channels \hat{Ψ}ᵢ^{lk}.

Step 612, the estimated logical channel matrixes Ĥᵢ^{l} are constructed according to the de-interleaved estimated logical channels \hat{Ψ}ᵢ^{lk}.

Step 613, the weighted coefficients W_{Ki} are computed according to the estimated logical channel matrixes Ĥᵢ^{l}.

Step 614, the de-interleaved logical data blocks Zᵢ^{l} are equalized by using the weighted coefficients W_{Ki} to generate the equalized logical data blocks Ŝᵢ^{k}.

Step 615, the equalized logical data blocks Ŝᵢ^{k} are recovered to generate the initial data blocks S_{Org}^{k}.

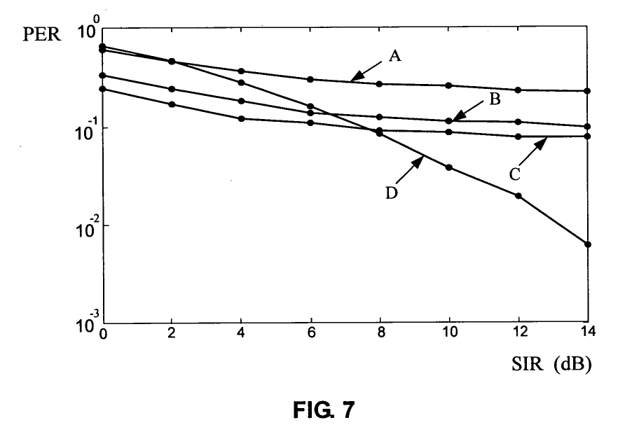

FIG. 7 is a schematic diagram showing a comparison of simulation results of the present invention and the prior art under the condition of 0 dB and 10 dB co-channel interferences respectively, wherein the ordinate axes indicates PER and the abscissa axes indicates SNR (signal to noise ratio) and the simulation environment is set as follows:

downlink: PUSC (Partial Usage Of Subchannels);

modulation mode: QPSK (Quadrature Phase Shift Keying);

code rate: ½;

data block size: 100 bytes;

co-channel interferences: a first co-channel interference with a SIR of 0 dB, a second co-channel interference with a SIR of 10 dB;

communication channel: ITU Ped-B (3 km/h);

combining technology adopted by a receiver: MRC; and

channel estimation method: ideal channel estimation.

Four simulation curves A, B, C and D in FIG. 7 show simulation results under different simulation conditions.

The simulation condition of curve A is:

code repetition rate: 4; and

antenna structure: SISO (Single Input Single Output), i.e. one transmitting antenna and one receiving antenna.

The simulation condition of curve B is:

code repetition rate: 6; and

antenna structure: SISO (Single Input Single Output), i.e. one transmitting antenna and one receiving antenna.

The simulation condition of curve C is:

code repetition rate: 4; and

antenna structure: SIMO (Single Input Multi Output) 1×2, i.e. one transmitting antenna and two receiving antennas.

The simulation condition of curve D is:

code repetition rate: 3; and

antenna structure: SISO (Single Input Single Output), i.e. one transmitting antenna and one receiving antenna.

FIG. 7 shows that curve D obtained by using the method for cancelling co-channel interferences provided by the present invention is much better than curves A, B and C which are obtained by using the conventional MRC technology. The BER of curve D can meet the requirement of the wireless communication with lower than 1% BER.

Upon reading this disclosure, those of skill in the art will appreciate still additional alternative structural and functional designs for cancelling co-channel interferences, in accordance with the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A system for cancelling co-channel interferences, the system comprising:
a transmitting apparatus and a receiving apparatus, wherein, the transmitting apparatus comprises:
a grouping module that groups the initial data blocks to generate grouped logical data blocks;
an interleaving module that interleaves the grouped logical data blocks to generate interleaved logical data blocks;
a repetition module that repeats the interleaved logical data blocks to generate repeated logical data blocks;
a permutation module that permutates the repeated logical data blocks to generate permutated physical data blocks; and
a transmitting module that transmits the permutated physical data blocks in a predefined manner;
the receiving apparatus comprises:
a receiving module that receives the physical data blocks in the predefined manner;
a data de-permutation module that de-permutates the received physical data blocks to generates de-permutated logical data blocks;
a data de-interleaving module that de-interleaves the de-permutated logical data blocks to generate de-interleaved logical data blocks;
a channel estimation module that separates and estimates physical channels of an objective base station and neighboring base stations according to preamble symbols or pilot symbols, de-permutates the estimated physical channels to generate the de-permutated estimated logical channels, de-interleaves the de-permutated estimated logical channels to generate the interleaved estimated logical channels, constructs the estimated logical channel matrixes by using the de-interleaved estimated logical channels, and computes weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;
an equalizing module that equalizes the interleaved logical data blocks by using the weighted coefficients to generate the equalized logical data blocks; and
a recovering module that recovers the equalized logical data blocks to generate the initial data blocks.

2. The system according to claim 1, wherein the channel estimation module comprises:
a physical channel estimation unit that separates and estimates the estimated physical channels of the objective base station and the neighboring base stations according to the received preamble symbols or pilot symbols.
a channel de-permutation unit that de-permutates the estimated physical channels to generate the de-permutated estimated logical channels;
a channel de-interleaving unit that de-interleaves the de-permutated estimated physical channels to generate the de-interleaved estimated logical channels;
an estimated logical channel matrix constructing unit that constructs the estimated logical channel matrixes according to the de-interleaved estimated logical channels; and
a weighted coefficient computing unit that computes the weighted coefficients according to the estimated logical channel matrixes.

3. A transmitting apparatus for cancelling co-channel interferences, the transmitting apparatus comprising:
a grouping module that groups the initial data blocks to generate grouped logical data blocks;
an interleaving module that interleaves the grouped logical data blocks to generate interleaved logical data blocks;
a repetition module that repeats the interleaved logical data blocks to generate repeated logical data blocks;
a permutation module that permutates the repeated logical data blocks to generate permutated physical data blocks; and
a transmitting module that transmits the permutated physical data blocks in a predefined manner.

4. A transmitting apparatus for cancelling co-channel interferences, the transmitting apparatus comprising:
a grouping module that groups the initial data blocks to generate grouped logical data blocks;
a repetition module that repeats the grouped logical data blocks to generate repeated logical data blocks;
an interleaving module that interleaves the repeated logical data blocks to generate interleaved logical data blocks;
a permutation module that permutates the repeated logical data blocks to generate permutated physical data blocks; and
a transmitting module that transmits the permutated physical data blocks in a predefined manner.

5. A receiving apparatus for cancelling co-channel interferences, the receiving apparatus comprising:
a receiving module that receives the physical data blocks in a predefined manner;
a data de-permutation module that de-permutates the received physical data blocks to generates de-permutated logical data blocks;
a data de-interleaving module that de-interleaves the de-permutated logical data blocks to generate de-interleaved logical data blocks;
a channel estimation module that separates and estimates physical channels of an objective base station and neighboring base stations according to preamble symbols or pilot symbols, de-permutates the estimated physical channels to generate the de-permutated estimated logical channels, de-interleaves the de-permutated estimated logical channels to generate the interleaved estimated logical channels, constructs the estimated logical channel matrixes by using the de-interleaved estimated logical channels, and computes weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;
an equalizing module that equalizes the interleaved logical data blocks by using the weighted coefficients to generate the equalized logical data blocks; and
a recovering module that recovers the equalized logical data blocks to generate the initial data blocks.

6. The receiving apparatus according to claim 5, wherein the channel estimation module comprises:
a physical channel estimation unit that separates and estimates the estimated physical channels of the objective base station and the neighboring base stations according to the received preamble symbols or pilot symbols.
a channel de-permutation unit that de-permutates the estimated physical channels to generate the de-permutated estimated logical channels;
a channel de-interleaving unit that de-interleaves the de-permutated estimated physical channels to generate the de-interleaved estimated logical channels;
an estimated logical channel matrix constructing unit that constructs the estimated logical channel matrixes according to the de-interleaved estimated logical channels; and
a weighted coefficient computing unit that computes the weighted coefficients according to the estimated logical channel matrixes.

7. A method for cancelling co-channel interferences, the method comprising:
grouping the initial data blocks to generate grouped logical data blocks;
interleaving the grouped logical data blocks to generate interleaved logical data blocks;
repeating the interleaved logical data blocks to generate repeated logical data blocks;
permutating the repeated logical data blocks to generate permutated physical data blocks; and
transmitting the permutated physical data blocks in a predefined manner.
receiving the physical data blocks in the predefined manner;
de-permutating the received physical data blocks to generate de-permutated logical data blocks;
de-interleaving the de-permutated logical data blocks to generate de-interleaved logical data blocks;
separating and estimating physical channels of an objective base station and neighboring base stations according to the preamble symbols or the pilot symbols, de-permutating the estimated physical channels to generate the de-permutated estimated logical channels, de-interleaving the de-permutated estimated logical channels to generate the interleaved estimated logical channels; constructing the estimated logical channel matrixes by using the de-interleaved estimated logical channels, computing weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;
equalizing the interleaved logical data blocks by using the weighted coefficients to generate the equalized logical data blocks; and
recovering the equalized logical data blocks to generate the initial data blocks.

8. The method according to claim 7, wherein
the permutation step and the de-permutation step are corresponding reversible processes; and
the interleaving step and the de-interleaving step are corresponding reversible processes.

9. The method according to claim 7, wherein
the predefined manner is a wired communication manner or a wireless communication manner.

10. The method according to claim 7, wherein
the estimated logical channel matrixes are full rank matrixes.

11. A method for cancelling co-channel interferences, the method comprising:
grouping the initial data blocks to generate grouped logical data blocks;
repeating the grouped logical data blocks to generate repeated logical data blocks;
interleaving the repeated logical data blocks to generate interleaved logical data blocks;
permutating the repeated logical data blocks to generate permutated physical data blocks; and
transmitting the permutated physical data blocks in a predefined manner.
receiving the physical data blocks in the predefined manner;
de-permutating the received physical data blocks to generate de-permutated logical data blocks;
de-interleaving the de-permutated logical data blocks to generate de-interleaved logical data blocks;
separating and estimating physical channels of an objective base station and neighboring base stations according to the preamble symbols or the pilot symbols, de-permutating the estimated physical channels to generate the de-permutated estimated logical channels, de-interleaving the de-permutated estimated logical channels to generate the interleaved estimated logical channels; constructing the estimated logical channel matrixes by using the de-interleaved estimated logical channels, computing weighted coefficients according to the estimated logical channel matrixes, wherein the physical channels of the objective base station are physical channels from the objective base station to the receiving apparatus and the physical channels of the neighboring base stations are physical channels from the neighboring base stations to the receiving apparatus;
equalizing the interleaved logical data blocks by using the weighted coefficients to generate the equalized logical data blocks; and
recovering the equalized logical data blocks to generate the initial data blocks.

12. The method according to claim 11, wherein
the permutation step and the de-permutation step are corresponding reversible processes; and
the interleaving step and the de-interleaving step are corresponding reversible processes.

13. The method according to claim 11, wherein
the predefined manner is a wired communication manner or a wireless communication manner.

14. The method according to claim 11, wherein
the estimated logical channel matrixes are full rank matrixes.
